(19) United States
(12) Patent Application Publication
(10) Pub. No.: US 2009/0033590 A1
(43) Pub. Date: Feb. 5, 2009

(54) Liquid crystal display with polarity reversion circuit and driving method thereof

(75) Inventor: Sha Feng, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/221,569

(22) Filed: Aug. 4, 2008

(30) Foreign Application Priority Data
Aug. 3, 2007 (CN) 200710075541.0

(51) Int. Cl. G09G 3/36

(52) U.S. Cl. 345/58

(57) ABSTRACT

A liquid crystal display includes one or more data drivers for outputting data signals, a processor, and at least two control units, each of which controls polarities of data signals of selected data drivers. The processor processes the data signals of the data drivers, and sends control signals to the control units. The control units control polarities of selected data signals to balance summing positive polarities and summing negative polarities of the data signals. A related method for driving the liquid crystal display is also provided.

### FIELD OF THE INVENTION

The present invention relates to liquid crystal displays (LCDs) and methods for driving LCDs, and particularly to an LCD with a polarity reversion circuit and a method for driving such LCD.

### GENERAL BACKGROUND

An LCD utilizes liquid crystal molecules to control light transmissivity in each pixel region of the LCD. The liquid crystal molecules are driven by external video signals received by the LCD. A typical LCD generally employs a 1-line dot inversion driving method to drive the liquid crystal molecules, so as to protect the liquid crystal molecules from decay or damage.

FIG. 6 is an abbreviated circuit diagram of a typical LCD. The LCD 100 includes a liquid crystal panel 10, a timing controller 101, a scanning circuit 102, a data circuit 103, and a common voltage generating circuit (not shown).

The liquid crystal panel 10 includes a plurality of parallel scanning lines G1 through Gn, a plurality of parallel data lines D1 through Dm orthogonal to the scanning lines G1 through Gn, and a plurality of pixels 130, where m is a number of columns of pixels 130 in the liquid crystal panel 10 and n is a number of rows of pixels 130 in the liquid crystal panel 10. The scanning lines G1 through Gn are electrically coupled to the scanning circuit 102, and the data lines D1 through Dm are electrically coupled to the data circuit 103. The scanning lines G1 through Gn do not intersect the data lines D1 through Dm.

Each pixel 130 includes a thin film transistor Qxy and a liquid crystal capacitor Cxy, where x and y are positive integers corresponding respectively to a position along the scanning lines G1 through Gn and the data lines D1 through Dm, and 1≦x≦n, 1≦y≦m. The thin film transistor Qxy is typically positioned close to one of the plurality of scanning lines G1 through Gn and one of the plurality of data lines D1 through Dm. A gate electrode (not labeled) of the thin film transistor Qxy is electrically coupled to the corresponding one of the plurality of scanning lines G1 through Gn, and a source electrode (not labeled) of the thin film transistor Qxy is electrically coupled to the corresponding one of the plurality of data lines D1 through Dm. A drain electrode (not labeled) of the thin film transistor Qxy is electrically coupled to the liquid crystal capacitor Cxy.

In operation, the scanning circuit 102 outputs a plurality of scanning signals to scan the plurality of scanning lines G1 through Gn successively. For example, when the scanning line G1 is scanned, the thin film transistors Q11 through Q1m are turned on simultaneously. Then the data circuit 103 outputs data signals to the liquid crystal capacitors C11 through C1m via the data lines D1 through Dm and the corresponding thin film transistors Q11 through Q1m. The common voltage generating circuit outputs common voltages to the liquid crystal capacitors C11 through C1m via common lines (not shown). After all the scanning lines G1 through Gn have been scanned in a frame period, the aggregation of light transmitting through the respective pixels 130 constitutes a portion of a display image on the liquid crystal panel 10.

The data signals applied to each liquid crystal capacitor Cxy include positive polarity data signals (+) and negative polarity data signals (−). A voltage value of each positive polarity data signal is greater than a voltage value of the common voltage, and a voltage value of each negative polarity data signal is less than the voltage value of the common voltage. A voltage difference between the positive polarity data signal/negative polarity data signal and the common voltage of each pixel 130 defines a gray level.

FIG. 7 illustrates a series of polarity patterns of the pixels of the typical LCD 100 employing the 1-line dot inversion system. A 4-by-4 sub-matrix of pixels of the LCD 100 is shown for exemplary purposes only to simplify the following explanation. In an (n−1)^{th} frame period, the odd pixels 130 of odd rows have positive polarities, the even pixels 130 of odd rows have negative polarities, the odd pixels 130 of even rows have negative polarities, and the even pixels 130 of even rows have negative polarities. In an n^{th} frame period, the polarities of all the pixels are reversed. In other words, the odd pixels 130 of odd rows have negative polarities, the even pixels 130 of odd rows have positive polarities, the odd pixels 130 of even rows have positive polarities, and the even pixels 130 of even rows have negative polarities. In an (n+1)^{th} frame period, the polarities of all of the pixels 130 are reversed to be the same as the (n−1)^{th} frame period.

The common voltage applied to the liquid crystal capacitors Cxy may be influenced by the data signals due to parasitic capacitors between the liquid crystal capacitors Cxy, the common lines, and the data lines D1 through Dm. If a total value of positive polarity data signals is greater than that of the negative polarity data signals, the common voltage is pulled up by the positive polarity data signals to a higher level than a desired value. If a total value of positive polarity data signals is less than that of the negative polarity data signals, the common voltage is pulled down by the negative polarity data signals to a lower level than the desired value. In other words, the common voltage shifts to an undesired level. When the common voltage shifts beyond a threshold level in one or more rows, a crosstalk phenomenon occurs, and the display quality of the LCD 100 is liable to be degraded accordingly.

Therefore an LCD and a driving method for the LCD are desired to overcome the above-described deficiencies.

### SUMMARY

A liquid crystal display includes a plurality of data drivers for outputting data signals, a processor, and at least two control units, each of which controls polarities of data signals of selected data drivers. The processor processes the data signals of the data drivers, and sends control signals to the at least two control units. The at least two control units respectively control polarities of selected data signals, in order to balance a summing of positive polarities and a summing of negative polarities of the data signals.

Other novel features and advantages will become more apparent from the following detailed description when taken in conjunction with the accompanying drawings.

### BRIEF DESCRIPTION OF THE DRAWINGS

FIG. 1 is an abbreviated circuit diagram of a first embodiment of an LCD, the LCD including a plurality of data drivers and a timing controller, the timing controller including a polarity reversion control circuit.

FIG. 2 is a block diagram of the polarity reversion control circuit of the timing controller of the LCD of FIG. 1.

FIG. 3 shows waveforms of data signals outputted by the data drivers of the LCD of FIG. 1.

FIG. 4 is an abbreviated circuit diagram of a second embodiment of an LCD.

FIG. 5 is an abbreviated circuit diagram of a third embodiment of an LCD.

FIG. 6 is an abbreviated circuit diagram of a typical LCD.

FIG. 7 illustrates a series of polarity patterns of a group of pixels of the LCD of FIG. 6.

### DETAILED DESCRIPTION OF THE EMBODIMENTS

Reference will now be made to the drawings to describe preferred and exemplary embodiments in detail.

FIG. 1 is an abbreviated circuit diagram of a first embodiment of an LCD. The LCD 20 includes a printed circuit board (PCB) 21, a plurality of flexible printed circuit boards (FPCBs) 22, and an LCD panel 23. In the embodiment of FIG. 1, the plurality of FPCBs 22 is ten for exemplary purposes only. The PCB 21 is electrically coupled to the LCD panel 23 via the FPCBs 22. Each FPCB 22 includes a data driver 24 positioned thereon. The PCB 21 includes a timing controller 25 for outputting data signals and polarity reversion control signals to the data drivers 24. The timing controller 25 includes a polarity reversion control circuit 26 for controlling polarities of the data signals outputted from the data drivers 24.

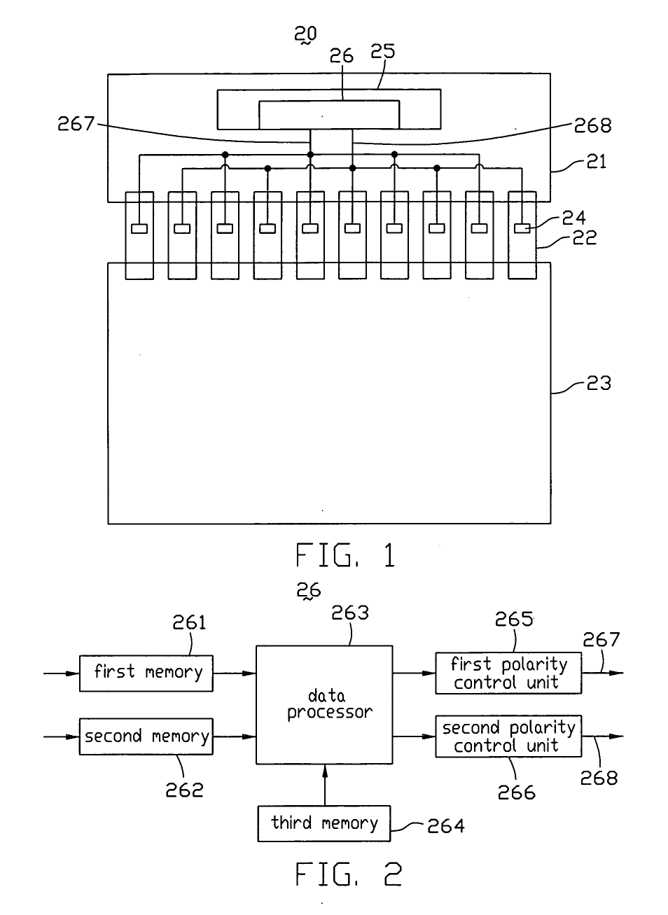

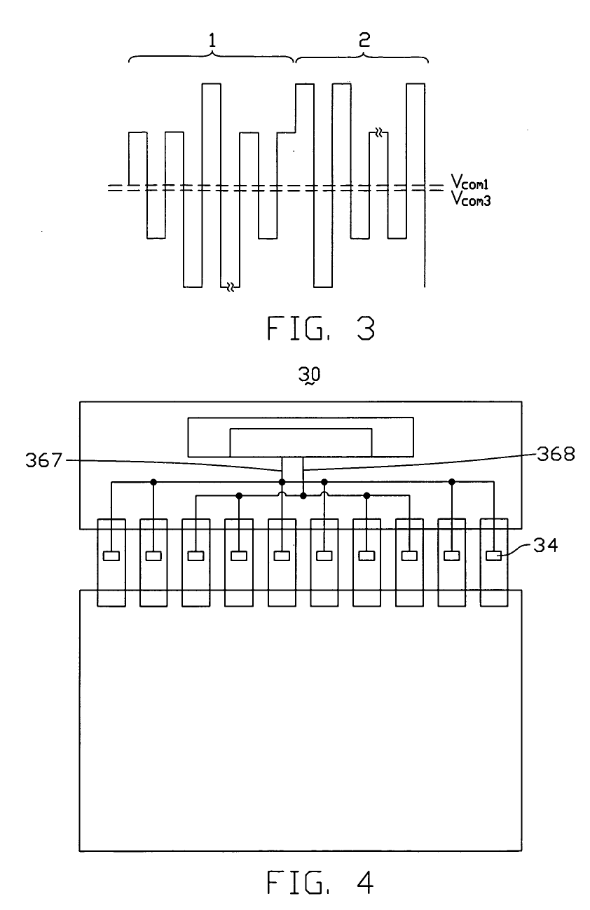

FIG. 2 is a block diagram of the polarity reversion control circuit 26. The polarity reversion control circuit 26 includes a first memory 261, a second memory 262, a data processor 263, a third memory 264, a first polarity control unit 265, and a second polarity control unit 266.

The first memory 261 stores data signals outputted to a plurality of odd data lines (not shown) of the LCD panel 23. The second memory 262 stores data signals outputted to a plurality of even data lines (not shown) of the LCD panel 23. The data processor 263 determines whether a crosstalk phenomenon is liable to occur in the LCD 20 and be manifest in an image (or images) displayed on the LCD panel 23. The first and second polarity control units 265, 266 respectively control polarities of the data signals outputted to the odd and even data lines. The third memory 264 stores a lookup table containing standards information for determining whether a crosstalk phenomenon is liable to occur. The standards information may be updated by users.

The first, second, and third memories 261, 262, 264 are connected to the data processor 263. The first polarity control unit 265 comprises an input terminal (not labeled) connected to the data processor 263, and an output terminal 267 connected to the odd data drivers 24. The second polarity control unit 266 comprises an input terminal (not labeled) connected to the data processor 263, and an output terminal 268 connected to the even data drivers 24.

A data signal of the LCD 20 may for example be in the form of an 8 bit binary number so that each pixel (not shown) of the LCD 20 has 256 gray levels from 0000 0000 to 1111 1111. The 0^{th} gray level 0000 0000 represents a darkest gray level, and the 256^{th} gray level 1111 1111 represents a brightest gray level. A detailed method for driving the LCD 20 is described below.

The timing controller 25 transmits data signals of one row into the polarity reversion control circuit 26, with the data signals (assuming that the polarities thereof are positive) of the odd pixels stored in the first memory 261, and the data signals (assuming that the polarities thereof are negative) of the even pixels stored in the second memory 262. The data processor 263 reads the data signals stored in the first memory 261, and adds the gray levels corresponding to the data signals to get a first summing of gray values. Simultaneously, the data processor 263 reads the data signals stored in the second memory 262, and adds the gray levels corresponding to the data signals to get a second summing of gray values. The data processor 263 subtracts the first summing of gray values from the second summing of gray values, to get a gray value difference. The data processor 263 compares the gray value difference with a standard value in the lookup table.

If the gray value difference is equal to or higher than the standard value, the data processor 263 determines that a crosstalk phenomenon is liable to occur. The data processor 263 sends control signals to the first and second polarity control units 265, 266 to output polarity control signals. The first polarity control unit 265 sends a first control signal POL1 to the odd data drivers 24 when the rows of pixels are scanned. The polarities of the data signals outputted by the odd data drivers 24 remain the same as before the first control signal POL1. The second polarity control unit 266 sends a second control signal POL2 to the even data drivers 24. The polarities of the data signals outputted by the even data drivers 24 are reversed to opposite polarities in accordance with the second control signal POL2.

If the gray value difference is smaller than the standard value, the data processor 263 determines that a crosstalk phenomenon is not liable to occur. The data processor 263 sends control signals to the first and second polarity control units 265, 266. The first and second polarity control units 265, 266 send control signals to the odd and even data drivers 24, respectively, to maintain the polarities of the data signals outputted by all of the data drivers 24 when data signals are applied to the data drivers 24.

FIG. 3 shows waveforms of the data signals outputted by the data drivers 24. Curve 1 represents data voltages outputted by the odd data drivers 24. The polarities of the data signals of curve 1 remain the same as before. Curve 2 represents data voltages outputted by the even data drivers 24. The polarities of the data signals of curve 2 are reversed to opposite polarities in accordance with the second control signal POL2. After reversing the polarities of the data signals, a summing of gray values of the data signals with positive polarities is compared to a summing of gray values of the data signals with negative polarities, so that a gray value difference between the positive and negative gray values decreases to a low level or is even eliminated. Accordingly, the common voltage shifts slightly. For example, the common voltage may shift slightly from Vcom1 to Vcom3. A negative influence to the display quality caused by the slight shift of the common voltage is small enough to be ignored, thereby minimizing or even eliminating any crosstalk phenomenon.

In the embodiment of FIG. 1, the polarity reversion control circuit 26 examines whether a crosstalk phenomenon is liable to occur in the LCD 20 and be manifest in an image (or images) displayed on the LCD panel 23. Once the crosstalk phenomenon is liable to occur, the polarity reversion control circuit 26 sends control signals to the data drivers 24 to reverse the polarities of the data signals outputted by the even data drivers 24, but maintains the polarities of the data signals outputted by the odd data drivers 24. Therefore, a gray value difference between a summing of gray values of the data signals with positive polarities and a summing of gray values of the data signals with negative polarities is decreased. The decreased gray value difference has little or even no influence on the common voltage, thereby minimizing or even eliminating any crosstalk phenomenon.

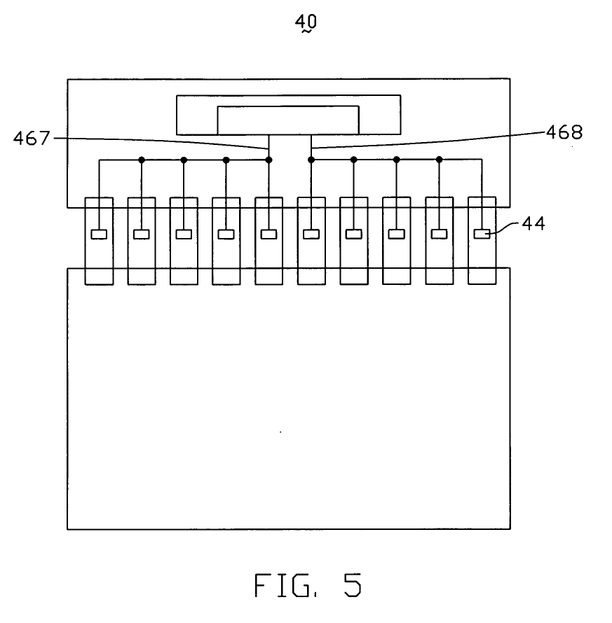

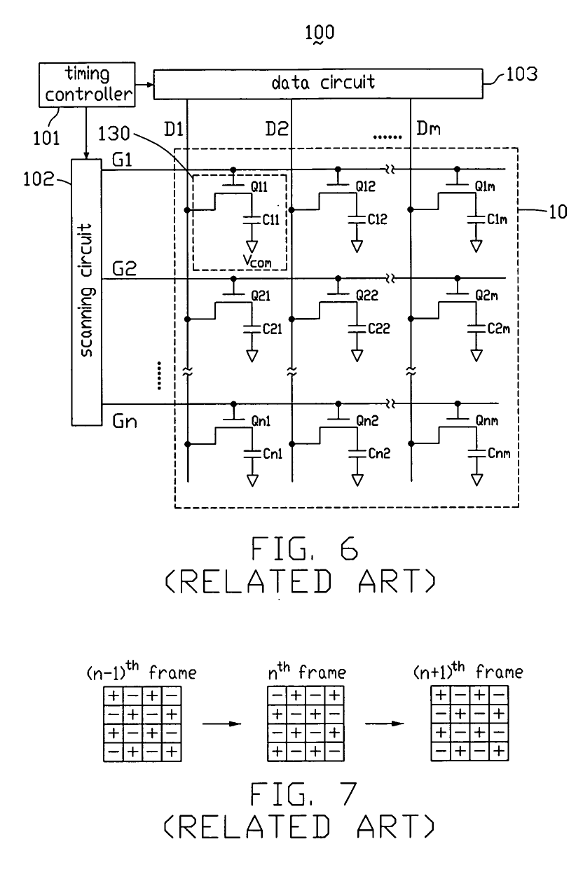

FIG. 4 is an abbreviated circuit diagram of a second embodiment of an LCD. The LCD 30 has a similar structure to the LCD 20 of FIG. 1, except that ten data drivers 34 are separated into five groups each of which includes two adjacent data drivers 34. An output terminal 367 of a first polarity control unit (not shown) is connected to the odd groups of the data drivers 24 for controlling polarities of data signals. An output terminal 368 of a second polarity control unit (not shown) is connected to the even groups of the data drivers 24 for controlling polarities of data signals.

FIG. 5 is an abbreviated circuit diagram of a third embodiment of an LCD. The LCD 40 has a similar structure to the LCD 20 of FIG. 1, except that data drivers 44 are separated into a first group of adjacent data drivers 44 and a second group of adjacent data drivers 44. In the illustrated embodiment, the first group includes the first five data drivers 44, and the second group includes the last five data drivers 44. An output terminal 467 of a first polarity control unit (not shown) is connected to the first group of data drivers 24 for controlling polarities of data signals. An output terminal 468 of a second polarity control unit (not shown) is connected to the second group of data drivers 24 for controlling polarities of data signals.

In other embodiments, the data drivers 24, 34, 44 may be separated into other groups, so long as one of the polarity control units (e.g., 265, 266) controls the polarities of some of the data drivers 24, 34, 44, and the other one of the polarity control units (e.g., 265, 266) controls the rest of the data drivers 24, 34, 44.

It is to be further understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A liquid crystal display, comprising:
a plurality of data drivers capable of outputting data signals;
a processor; and
at least two control units, each control unit configured to control polarities of the data signals outputted by a respective preselected plurality of the plurality of data drivers;
wherein the processor is capable of receiving input data signals, determining whether a crosstalk phenomenon is liable to occur and be manifest in an image displayed by the LCD according to positive and negative polarities of the input data signals, and on a condition that a crosstalk phenomenon is liable to occur, sending control signals to the at least two control units such that at least one of the at least two control units controls polarities of the data signals outputted by the corresponding plurality of the plurality of data drivers to balance a summing of positive polarities of the data signals outputted by the plurality of data drivers and a summing of negative polarities of the data signals outputted by the plurality of data drivers.

2. The liquid crystal display of claim 1, further comprising a first memory connected to the processor, a second memory connected to the processor, and a plurality of data lines connected to the corresponding data drivers, wherein the first memory is capable of storing data signals corresponding to a first plurality of the plurality of data lines, and the second memory is capable of storing data signals corresponding to a second plurality of the plurality of data lines.

3. The liquid crystal display of claim 2, further comprising a third memory that stores a lookup table, the lookup table comprising standards information for determining whether a crosstalk phenomenon is liable to occur according to polarities of the input data signals.

4. The liquid crystal display of claim 3, wherein the processor is configured to add gray levels of the data signals from the first memory to get a first summing of gray values, add gray levels of the data signals from the second memory to get a second summing of gray values, compare the first summing of gray values with the second summing of gray values to get a gray value difference, and compare the gray value difference with the standards information stored in the third memory to determine whether a crosstalk phenomenon is liable to occur.

5. The liquid crystal display of claim 1, wherein the at least two control units comprise a first control unit and a second control unit.

6. The liquid crystal display of claim 5, wherein the first control unit is connected to odd data drivers of the plurality of data drivers; and the second control unit is connected to even data drivers of the plurality of data drivers.

7. The liquid crystal display of claim 5, wherein the plurality of data drivers are divided into a plurality of data driver groups; each data driver group comprises at least two adjacent data drivers; the first control unit is connected to odd data driver groups; and the second control unit is connected to even data driver groups.

8. The liquid crystal display of claim 7, wherein each data driver group comprises two adjacent data drivers.

9. The liquid crystal display of claim 5, wherein the plurality of data drivers are divided into a first group of adjacent data drivers and a second group of adjacent data drivers; the first control unit is connected to the first group; and the second control unit is connected to the second group.

10. A driving method for a liquid crystal display, the driving method comprising:
providing a liquid crystal display comprising a plurality of data drivers configured for outputting data signals, a processor, and at least two control units configured for controlling polarities of the data signals outputted by the data drivers;
receiving data signals by the processor;
determining whether a crosstalk phenomenon is liable to occur and be manifest in an image displayed by the liquid crystal display according to positive and negative polarities of the data signals received by the processor; and
reversing polarities of a plurality of the data signals outputted by the data drivers to balance the positive and negative polarities of the data signals outputted by the data drivers by cooperation of the processor and the at least two control units if a crosstalk phenomenon is liable to appear.

11. The driving method of claim 10, wherein the data signals received by the processor are divided into at least two groups when crosstalk phenomenon is liable to appear; and the processor controls at least one of the at least two control units to reverse polarities of at least one group of data signals.

12. The driving method of claim 10, wherein the liquid crystal display further comprises a plurality of data lines connected to the data drivers.

13. The driving method of claim 12, wherein polarities of the data signals corresponding to odd data lines are reversed when crosstalk phenomenon is liable to appear.

14. The driving method of claim 12, wherein the at least two control units comprise a first control unit and a second control unit.

15. The driving method of claim 14, wherein the first control unit is connected to odd data drivers, the second control unit is connected to even data drivers.

16. The driving method of claim 14, wherein the data drivers are separated into a plurality of data driver groups, the first control unit is connected to odd data driver groups, the second control unit is connected to even data driver groups.

17. The driving method of claim 10, wherein the liquid crystal display further comprises a first memory connected to the processor, a second memory connected to the processor, and a plurality of data lines connected to the corresponding data drivers, wherein the first memory stores data signals corresponding to a first part of the plurality of data lines; the second memory stores data signals corresponding to a second part of the plurality of data lines.

18. The driving method of claim 17, wherein the liquid crystal display further comprises a third memory that stores a lookup table, the lookup table comprises standard information for determining whether a crosstalk phenomenon is liable to appear in accordance with polarities of the data signals.

19. The driving method of claim 18, wherein the processor adds gray levels of the data signals from the first memory to get a first summing gray value, adds gray levels of the data signals from the second memory to get a second summing gray value, and compares the first and second summing gray values to get a gray value difference, the gray value difference is compared with the standard stored in the third memory to confirm whether crosstalk phenomenon is liable to appear.
